(19) United States
(12) Patent Application Publication
(10) Pub. No.: US 2008/0163269 A1
(43) Pub. Date: Jul. 3, 2008

(54) Remote procedure call system, remote procedure call method, program for implementing remote procedure call system

(75) Inventor: Hisashi Goto, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/904,104

(22) Filed: Sep. 26, 2007

(30) Foreign Application Priority Data
Dec. 27, 2006 (JP) 2006-351831

(51) Int. Cl. G06F 9/46

(52) U.S. Cl. 719/330

(57) ABSTRACT

Input/output data classes defined based on an interface between a server and a client are embedded in a client application, and input/output data objects, which are instances of the input/output data classes, are generated when the client application calls a server application with a remote procedure call. When the client receives a reply message from the server, a data conversion for output parameters is not performed, and the output parameters are transferred unchanged to the data region of the output data object. Thereafter, when the client application references an output parameter, an obtainment process for the corresponding parameter of the output data object is called, the data conversion is performed only for the output parameter required for the obtainment process, and the value of the output parameter referenced by the client application is returned.

### BACKGROUND OF THE INVENTION

1. Field of the Invention

The present invention relates to a remote procedure call (RPC) method, and more particularly to, an information processing device, system, etc, which execute a remote procedure call process.

2. Description of the Related Art

In recent years, a system where a client application uses a server application via a network has been popularized.

In such a system, normally, an application on a client communicates with an application on a server, which comprises a TP (Transaction Processing) monitor, with a remote procedure call process, and executes a process as shown in FIG. 1.

As methods for developing a system to which a remote procedure call mechanism is applied, two techniques such as a top-down technique and a bottom-up technique are known. A difference between these two techniques exists in a procedure, which is the keystone of a remote procedure call, for designing/creating an interface between a client and a server.

The top-down technique is a technique suitable for a case where applications of both a client and a server are newly designed from scratch, and the design/creation of an interface by using an IDL (Interface Definition Language), which is not dependent on the programming languages of both of the applications, is the starting point of development. Stubs and interface definition information, which are required to develop both of the applications, are automatically generated from the IDL with a tool.

The bottom-up technique is a technique suitable for a case where a new service is designed by reusing an existing server application, and interface definition information, which is the programming resources of an existing server application, is the starting point of development. IDL required for development on a client is automatically generated from existing interface definition information with a tool.

Nowadays, a service oriented development technique (SOA: Service Oriented Architecture) becomes widespread, and the bottom-up technique is widely adopted as a system configuration technique using an existing server application on a TP monitor.

This document provides an explanation by taking as an example a case where the bottom-up technique is adopted as a development technique. However, a scope where the present invention is applied is not limited to the case where the bottom-up technique is adopted.

FIG. 2 shows the details of an example of a system for executing an application with a remote procedure call process.

FIG. 2 depicts both a development environment 2701 and an operation environment 2702.

Initially, when an application is developed, an IDL 2703 is generated by using an interface definition conversion tool 2707, etc. from interface definition information 2705 between applications of a client 2710 and a server 2709 in the development environment 2701. Stubs 2706 for the client and the server are generated from the IDL 2703 with an IDL compiler 2708, etc. The generated stubs are embedded respectively in a client application 2722 and a server application 2711 as a client stub 2720 and a server stub 2714.

Additionally, when the application is developed, location information of the server application is registered to a remote procedure call location managing unit (naming service) 2717, which is a database of a TP monitor 2704 within the server 2709.

When the system is operated, namely, when the server application 2711 is called from the client application 2722 and executed on the client 2710, a remote procedure call client mechanism 2719 within the client 2710 obtains the location information of the server application from the remote procedure call location managing unit (naming service) 2717, and the client application 2722 makes a connection to a remote procedure call server mechanism 2718 via the client stub 2720 and the remote procedure call client mechanism 2719 based on the network address of the server application within the location information.

Then, a distribution mechanism 2715 within the TP monitor 2704 distributes a request message (Request), which is issued from the client 2710 to the server 2709, to the server stub 2714 corresponding to the server application 2711 based on server application identification information within the location information. Additionally, the server application 2711 returns a reply message (Reply), which is to be transmitted to the client 2710, to the client application 2722 on the same route where the request message is transmitted. Note that the interface definition information 2705 at the time of system development, and the interface definition information 2713 at the time of operation are the same. However, they are depicted as shown in FIG. 2 in order to provide an explanation about the information at the time of development and operation.

As described above, the server stub 2714 and the client stub 2720 convert (encode/decode) a communication message such as a request message, a reply message, etc., which includes input/output parameters of an IDL definition, and transfer the message.

However, as shown in FIG. 3, there is a problem such that, for the reply message, the overhead of a process for converting (decoding) parameters increases in proportion to the number of output parameters, and performance at the time of process execution deteriorates since the client stub automatically converts (decodes) all the parameters regardless of whether or not the client application actually references the parameters when the output parameters are notified from the stub to the client application.

Accordingly, it is desirable to improve the performance at the time of process execution by executing a process for a conversion between remote procedure call messages, especially, a conversion (decoding) for an output parameter, with a restriction imposed only to a parameter referenced by the client application.

In the meantime, Patent Document 1 discloses a technique for reducing a code amount on a client side by generating a remote procedure call program only for a remote procedure used by a client application, and for saving a memory amount required to load the program. Namely, the code amount is reduced (reductions are made in units of stubs) by predefining a client stub, which is not used by the client application, with a generation specification definition, and by bypassing the generation of the stub. This conventional technique is similar to the present invention in a point that this is a technique for reducing the code amount on the client side. However, it can be said that Patent Document 1 reduces a static program size, but the present invention aims at reducing steps at the time of execution, and the contents of the reductions are different although both of the techniques reduce the code amount. Additionally, Patent Document 1 does not refer to improvements in the performance at the time of program execution, which are made by reducing the execution steps of the client. According to the present invention, decoding is made as the extension of a process for obtaining an output parameter, which is called by referencing the output parameter from a client application, and the decoding of a parameter not referenced is bypassed (reductions are made in units of parameters).

Furthermore, the following Patent Documents 2 and 3 exist in addition to the above described Patent Document 1 as documents for conventional techniques related to the present invention.

Patent Document 2 and the present invention are common in a point of having a feature (hereinafter referred to as a common I/F property) with which a server can be called from a client by using the same interface in a remote procedure call even if usage is different. According to Patent Document 2, this feature relates to the object, and the effect itself of solving the object, and the common I/F property is implemented by comprising means, which is called service process request means for concealing and encapsulating a difference in middleware use, and means for absorbing the difference within the middleware. In the meantime, the present invention does not aim at this feature, and only has the feature of the common I/F property as an implementation method for solving the object to improve the performance at the time of execution, and the common I/F property of the present invention is implemented by solving the object (improvements in performance) with a data class which encapsulates all parameters of process results of a server. Accordingly, the present invention is different from the technique recited in Patent Document 2.

Patent Document 3 and the present invention are common in a point that these are techniques related to encoding/decoding in a remote procedure call, namely, a process for passing parameters/process results via a data region.

However, Patent Document 3 aims at preventing a region from being uncollected in a garbage collection, and achieves the object by comprising a distribution region managing apparatus having the same structure on client and server sides, and by mutually exchanging information. A difference exists in a point that an object of the present invention is to improve performance at the time of execution by bypassing an unnecessary decoding process, and the present invention achieves the object by encapsulating parameters, and implements the object only with a process on a client side.

Patent Document 1: Japanese Published Unexamined Patent Application No. H6-67865

### Patent Document 2: Japanese Published Unexamined Patent Application No. 2004-240890

Patent Document 3: Japanese Published Unexamined Patent Application No. H6-75884

### SUMMARY OF THE INVENTION

In light of the above description, an object of the present invention is to provide an apparatus and a method, which are intended to improve performance at the time of execution by performing a data conversion for an output parameter in an exchange of communication messages with a restriction imposed to a necessary output parameter, and by reducing an overhead of a data conversion for output parameters in a conventional system, in a system implemented in a way such that a client application calls a server application with a remote procedure call.

To overcome the above described problems, the present invention is configured so that input/output data classes defined based on an interface between a server and a client are embedded in a client application, and input/output data objects, which are instances of the input/output data classes, are generated when the client application calls a server application with a remote procedure call. Additionally, the present invention is configured so that a data conversion is not performed for output parameters when the client receives a reply message from the server, the output parameters are transferred unchanged to a data region of the output data object without performing the data conversion for the output parameters, and thereafter, when the client application references an output parameter, an obtainment process for the corresponding parameter of the output data object is called, the data conversion is performed only for the output parameter required for the obtainment process, and the value of the output parameter referenced by the client application is returned.

With this configuration, the input/output parameters when the server applications is called can be encapsulated with input/output data objects and exchanged, and the data conversion for an output parameter can be restricted only to an output parameter referenced by the client application.

According to the present invention, input/output parameters when the server application is called with a remote procedure call can be encapsulated with input/output data objects and exchanged. Additionally, the data conversion process for an output parameter is performed by calling an obtainment process for a corresponding parameter of the data object when the output parameter is referenced by the client application, whereby an overhead in a conventional data conversion process can be reduced, and performance at the time of execution can be improved.

### BRIEF DESCRIPTION OF THE DRAWINGS

FIG. 1 is a schematic explaining a remote procedure call;

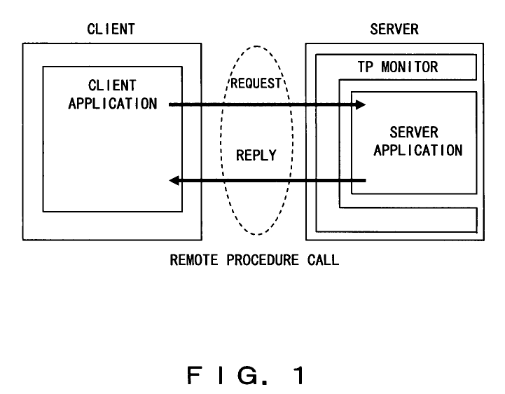

FIG. 2 is a schematic exemplifying a system for executing a conventional remote procedure call process;

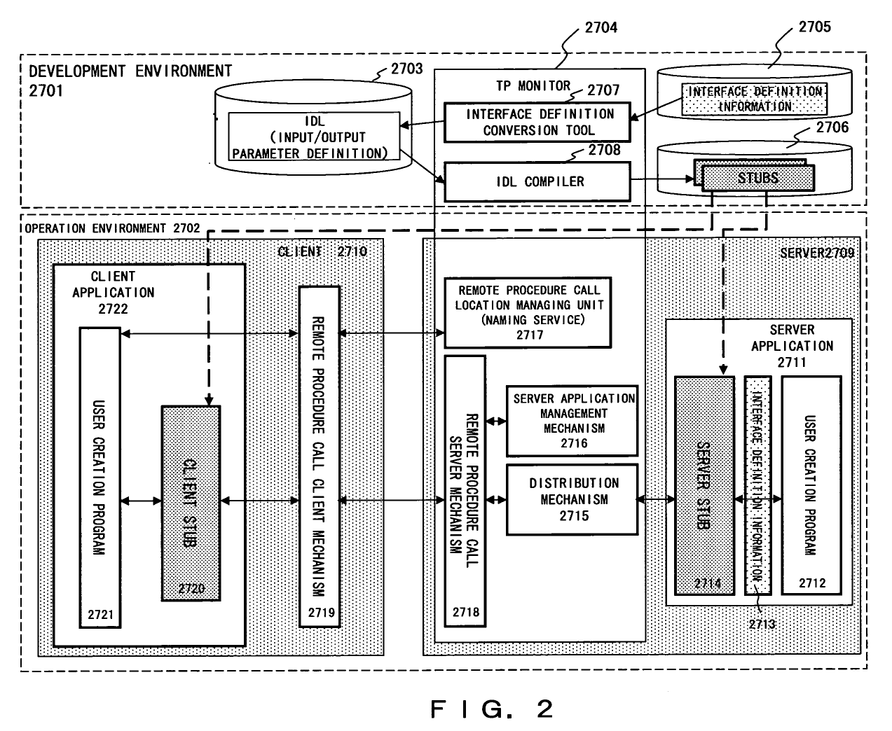

FIG. 3 is a schematic showing the problems of conventional techniques;

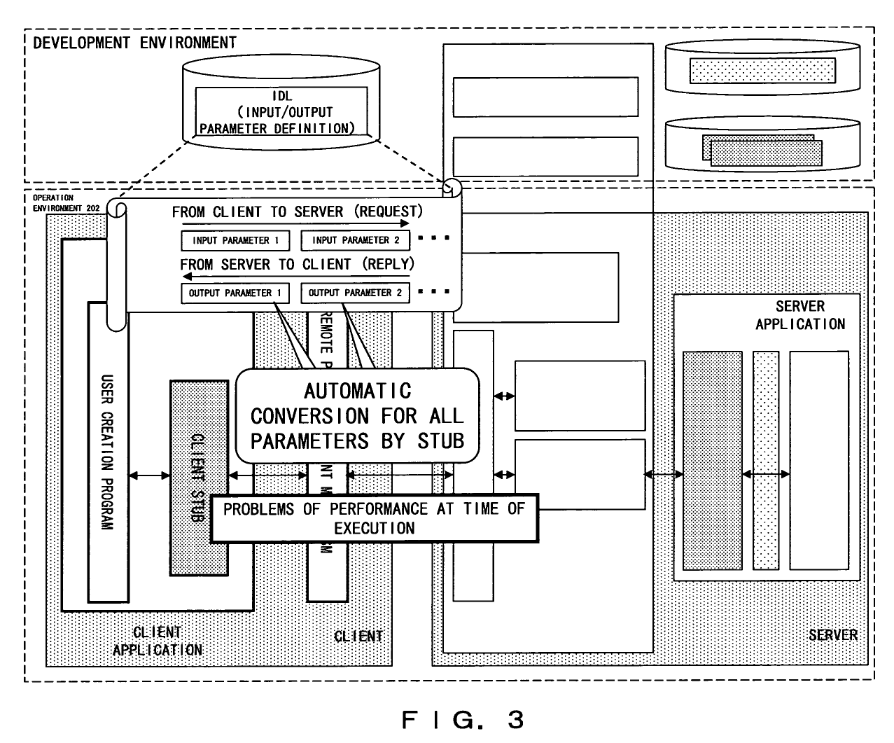

FIG. 4 is a block diagram showing the outline of a remote procedure call system according to the present invention;

FIG. 5 is a schematic showing a preferred embodiment according to the present invention;

FIG. 6 is a schematic showing a process flow of FIG. 5;

FIG. 7 is a schematic explaining the details of a data conversion for an output parameter;

FIG. 8 is a schematic explaining the data conversion for an output parameter with reference to a data structure;

FIG. 9 is a schematic explaining an effect of the present invention;

FIG. 10 is a schematic showing the system configuration of an implementation example;

FIG. 11 is a block diagram showing a hardware configuration of an information processing device implementing a server and a client in the implementation example;

FIG. 12 is a schematic showing a “stock price reference” input data class in the implementation example;

FIG. 13 is a schematic showing a “stock price reference” output data class in the implementation example;

FIG. 14 is a schematic showing a service adapter class in the implementation example;

FIG. 15 is a flowchart showing a flow at the time of stock price reference in the implementation example;

FIG. 16 is a schematic showing the structure of a “stock price reference” request message;

FIG. 17 is a schematic explaining the outline of request message creation;

FIG. 18 is a schematic showing the structure of a “stock price reference” reply message;

FIG. 19 is a schematic explaining the outline of extraction of output parameters;

FIG. 20 is a flowchart showing the details of a flow of (1) adapter instance generation;

FIG. 21 is a flowchart showing the details of a flow of (2) instance generation, and (3) location information obtainment;

FIG. 22 is a flowchart showing the details of a flow of (6) input parameter settings;

FIG. 23 is a flowchart showing the details of a flow of (7) stock ID setting process, and (8) stock ID conversion;

FIG. 24 is a flowchart showing the details of a flow of (11) server application “stock price reference” call;

FIG. 25 is a flowchart showing the details of a flow of (12) request message creation;

FIG. 26 is a flowchart showing the details of a flow of (13) request message transmission;

FIG. 27 is a flowchart showing the details of a flow of (14) reply message reception, and (15) output parameter extraction;

FIG. 28 is a flowchart showing the details of a flow of (16) output parameter reference, (17) obtainment process, and (18) output parameter conversion; and

FIG. 29 is a schematic explaining the loading of a program into an information processing device (computer).

### DESCRIPTION OF THE PREFERRED EMBODIMENTS

A preferred embodiment according to the present invention is described below with reference to the drawings.

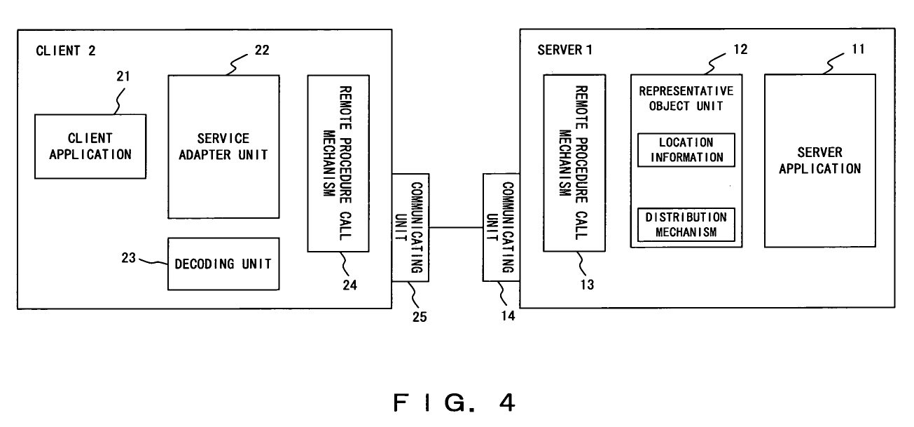

FIG. 4 shows the outline of a remote procedure call system according to the present invention.

The system is configured with a server 1, and a client 2.

The client 2 includes a client application 21, a service adapter unit 22, a decoding unit 23, a remote procedure call mechanism 24, and a communicating unit 25. The server 1 includes a server application 11, a representative object unit 12, a remote procedure call mechanism 13, and a communicating unit 14.

The service adapter unit 22 calls a server application with input/output data classes for the remote procedure call mechanism, and one unit exists in the client 2.

The representative object unit 12 includes a server application distribution mechanism for routing the definition amount of location information required for the remote procedure call of the server application in units of servers in response to a service request of the service adapter unit 22, and has the location information of the server application. One representative object unit exists in the server 1.

The communicating units 14 and 25 exist respectively in the server 1 and the client 2, and implement a communication using 1 data type, which is not dependent on the data type of an input/output data parameter defined in an input/output data class, between the service adapter unit and the representative object unit.

The decoding unit 23 performs a data conversion by restricting the decoding of a reply message, which is returned from the server 1 in response to a service request, in the client 2 to the range of a parameter referenced by the client application 21, and outputs the converted data.

As a result, the data conversion for an output parameter can be restricted to the range of a parameter referenced by the client application when the client application calls the server application with a remote procedure call, whereby an overhead in a conventional data conversion can be improved.

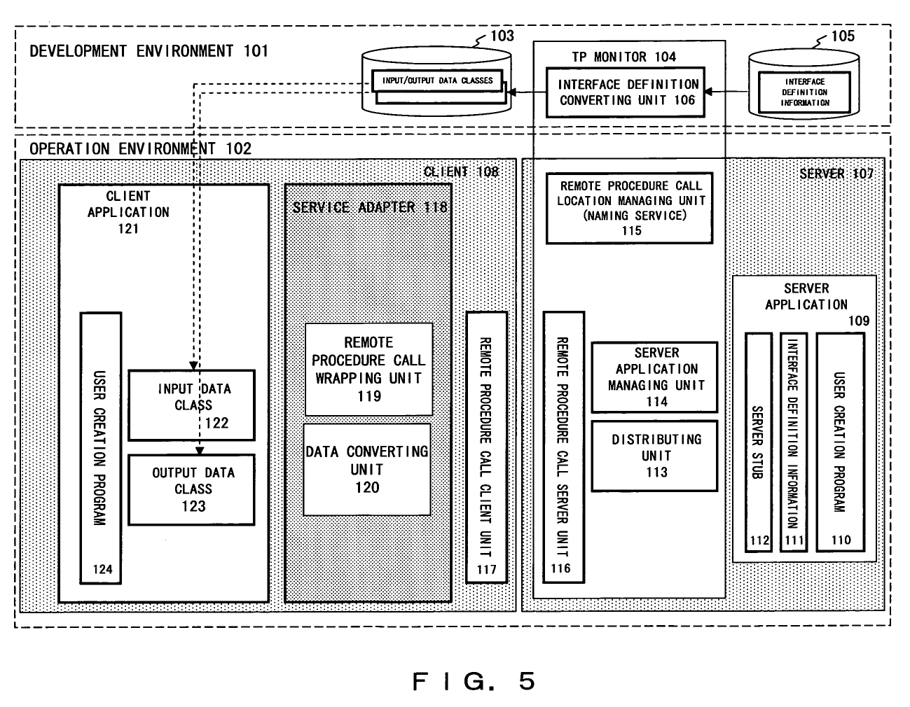

Next, a preferred embodiment according to the present invention is shown in FIG. 5. FIG. 5 shows a system where a server application is executed on a client with a remote procedure call.

FIG. 5 depicts both a development environment 101 and an operation environment 102.

Initially, when an application is developed, input/output data classes 103 are generated by an interface definition converting unit 106 from interface definition information 105 between applications on a client 108 and a server 107 in the development environment 101. The generated input/output data classes 103 are embedded in a client application 121 as an input data class 122 and an output data class 123. When the client application 121 calls a plurality of server applications 109, pluralities of input/output classes are embedded in the client application 121. Also a server stub 112 is generated by the interface definition converting unit 106, and embedded in the server application 109.

When the system is operated, the system is configured with the server 107 and the client 108.

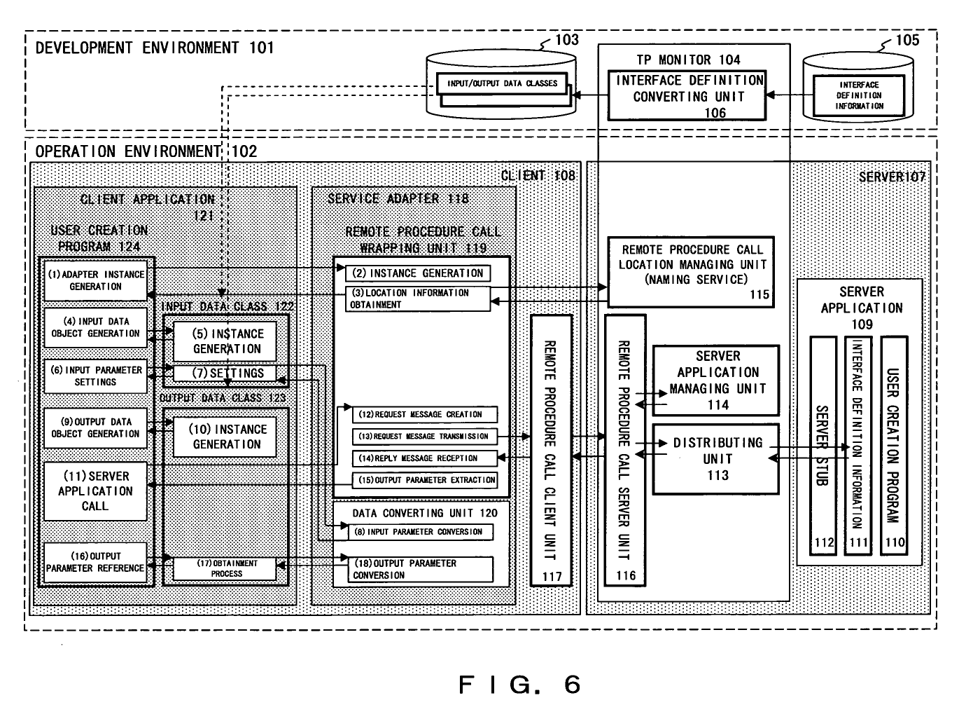

The server 107 is composed of a server application 109 and a TP monitor 104. Additionally, the server application 109 is composed of a user creation program 110, which is the principal portion of the application, interface definition information 111, and a server stub 112. The TP monitor 104 is composed of a remote procedure call location managing unit (naming service) 115, a server application managing unit 114, a distributing unit 113, and a remote procedure call server unit 116. Although the interface definition information 105 at the time of development, and the interface definition information 111 at the time of system operation are the same, they are depicted as shown in FIG. 5 in order to provide an explanation about the information at the time of development and system operation (the same is applied also to FIG. 6 to be described later).

In the meantime, the client 108 is composed of a client application 121, a service adapter 118, and a remote procedure call client unit 117.

The client application 121 is composed of an input data class 122 and an output data class 123, which are generated at the time of development, and a user creation program 124, which is the principal portion of the application.

The service adapter 118 is composed of a remote procedure call wrapping unit 119, and a data converting unit 120. The remote procedure call wrapping unit 119 includes a conventional client stub process, and executes a process for making a communication between the client application 121 and the server application 109. The data converting unit 120 executes a data conversion process for an input/output parameter.

One service adapter 118 exists in the client 108, and operates as the client application 121 for the remote procedure call units 116 and 117 of both the server 107 and the client 108.

The system configuration shown in FIG. 5 achieves the object to reduce a conventional overhead in a conversion for a communication message of a remote procedure call by using the service adapter, which comprises the remote procedure call wrapping unit 119 and the data converting unit 120, the input data class 122, and the output data class 123. Namely, since the data conversion for an output parameter in the data converting unit 120 is executed by targeting only a corresponding parameter when the obtainment process for the parameter of the output data object is called, a useless process in the conventional data conversion process can be omitted.

Correspondences between the respective constituent elements in FIGS. 4 and 5 are as follows. The service adapter unit 22 of FIG. 4 corresponds to the service adapter 118 of FIG. 5, the representative object unit 12 of FIG. 4 is included in the TP monitor 104 although this is not shown in FIG. 5, the communicating unit of FIG. 4 corresponds to a communication interface between the client and the server, which implements a communication and is not explicitly shown in FIG. 5, and the decoding unit of FIG. 4 corresponds to the data converting unit 120 of FIG. 5.

Next, the flow of the system shown in FIG. 5 is described in detail with reference to FIG. 6.

Initially, the user creation program 124 within the client application 121 makes (1) generation of an instance of the service adapter 118 before the server application 109 is called.

With the process for the service adapter class, which is called in (1), (2) instance generation is made, (3) obtainment of location information of the server application is made from the remote procedure call location managing unit (naming service) 115, and control is returned to the call source.

Next, the user creation program 124 makes (4) input data object generation, whereby (5) instance generation is made.

Then, the user creation program 124 makes (6) input parameter settings. (7) input parameter setting process is made to run by calling the input parameter setting process of the input data object. The input parameter setting process calls (8) input parameter conversion performed by the data converting unit 120 of the service adapter 118, converts input parameters, and sets the converted values.

Furthermore, the user creation program 124 makes (9) output data object generation, whereby (10) generation of the instance of the output data class is made. The client application 121 requests (11) call of the server application 109 by specifying an input/output object.

The remote procedure call wrapping unit 119 of the service adapter 118 executes processes in the order of (12) creation of a request message, which is a communication message for conveying a request from the client, (13) transmission of the request message, (14) reception of a reply message, which is a communication message for conveying a reply from the server, and (15) extraction of output parameters from the reply message, and then, control is returned to the request source.

An output parameter obtainment process for the output data object is called so that the user creation program 124 makes (16) output parameter reference, whereby (17) output parameter obtainment process is made to run. (17) obtainment process performs a data conversion only for an output parameter to be obtained by calling (18) output parameter conversion performed by the data converting unit 120 of the service adapter 118, and returns the parameter to the user creation program 124.

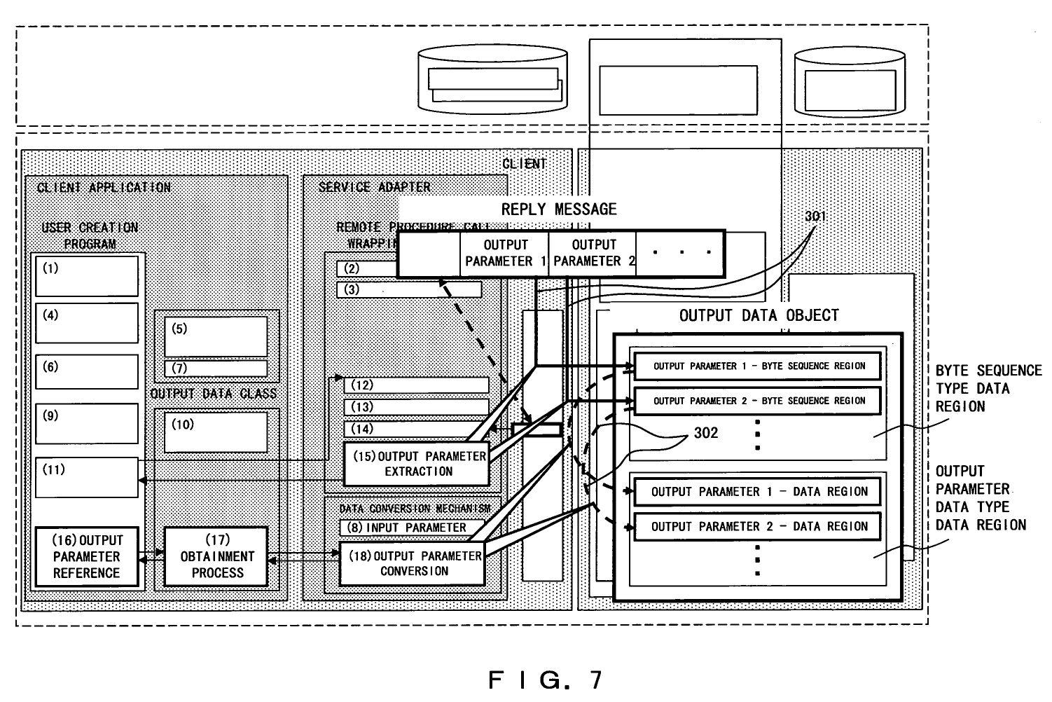

The system shown in FIG. 5 runs in accordance with the above described flow. The processes of (15) to (18) of FIG. 6, which are intended to execute the data conversion process for an output parameter referenced by the application, are described in further detail with reference to FIG. 7.

The data region of the output data object includes a byte sequence type data region for storing the output parameters of a received reply message unchanged, and an output parameter data type data region for storing data, which is the original data type of an output parameter and with which the output data object exchanges a parameter with the call source.

As indicated by a solid-line arrow 301 from an output parameter portion within a reply message of FIG. 7 to a byte sequence type data region, the output parameters of the reply message passed via the remote procedure call client unit 117 in (14) reply message reception are copied to the byte sequence type data region (an output parameter 1-byte sequence region to an output parameter N-byte sequence region) within the data region of the output data object in (15) output parameter extraction.

Additionally, as indicated by a dotted-line arrow 302 from the byte sequence type data region (the output parameter 1-byte sequence region, etc.) of FIG. 7 to the parameter data type data region, (17) obtainment process for the corresponding parameter of the output data object is called when the user creation program 124 makes (16) output parameter reference. With this obtainment process, (18) output parameter conversion process is executed, data of the byte sequence type data region is converted into data according to the data type of the parameter, and stored in the parameter data type data region.

(18) output parameter conversion process of FIG. 6 is executed only at an opportunity when the user creation program 124 makes the output parameter reference. Namely, for a parameter that the user creation program 124 does not reference, information is stored in the byte sequence type data region in the data region of the output data object, but information continues not to be stored in the output parameter data type data region.

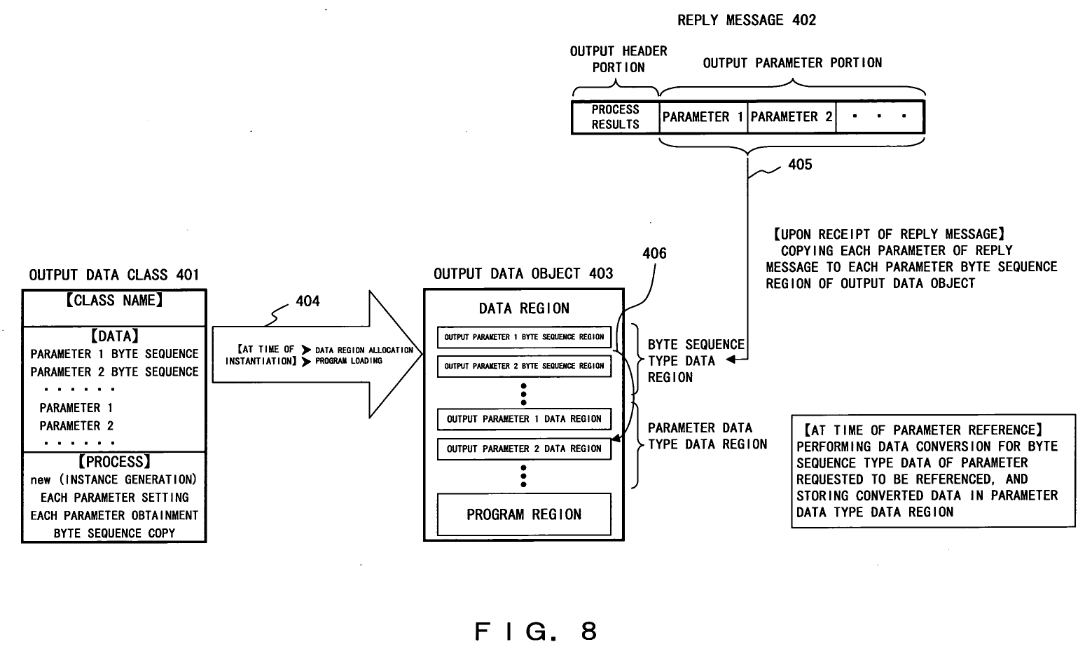

Furthermore, data structures of the reply message, the output data class, and the output data object, which relate to the data conversion for an output parameter, are shown in FIG. 8, and the details of the process are explained.

Initially, the output data class 401 is composed of a class name, a data portion, and a process portion. The data portion is composed of a byte sequence type data region (the parameter 1 byte sequence, the parameter 2 byte sequence, etc. within the output data class 401 of FIG. 8), and a parameter data type data region (the parameter 1, the parameter 2, etc. within the output data class 401 of FIG. 8), which is the original data type of a parameter. The process portion is composed of a method for making instance generation, a method for making each parameter setting, a method for making each parameter obtainment, a method for making byte sequence type data copy, etc.

The output data object 403 is an instance of the output data class 401. This object allocates a data region corresponding to the data portion of the output data class 401 to a storage region of a RAM (Random Access Memory), etc. of an information processing device that implements the client, and loads a program corresponding to the process portion of the class into a program region of the output data object 403 of FIG. 8, at the time of instantiation (an arrow 404). In the data region of the output data object 403, a byte sequence type data region for storing the byte sequence type data of a parameter, and a parameter data type data region for storing the data of the parameter itself are allocated for each parameter. The instantiation of FIG. 8 (the arrow 404) corresponds to (10) instance generation of FIG. 6.

Furthermore, the reply message 402, which is a reply from the server to the client, is composed of an output header portion including process results such as whether the process terminates either successfully or unsuccessfully, etc., and an output parameter portion. The output parameter portion has a structure where byte sequence type data corresponding to each parameter of the output data class 401 is sequentially arranged. Accordingly, (15) parameter extraction of FIG. 6, which is made upon receipt of the reply message, only copies the output parameter portion of the storage region included in the reply message 402 to the byte sequence type data region of the data region of the output data object 403 (an arrow 405 of FIG. 8) in a sequential manner.

Next, an output parameter within the output data object 403 is converted when the user creation program 124 makes an output parameter reference ((16) output parameter reference of FIG. 6). Namely, the data conversion for the output parameter is made at the opportunity when the user creation program 124 makes a reference request to call the parameter reference process (the obtainment method for each parameter) in the output data object 403. Information about the data type of an output parameter is buried in the obtainment method of each output parameter, and the method grasps the byte sequence type data region of the parameter within the output data object. The obtainment method of each output parameter calls the output parameter conversion process, which is executed by the data converting unit 120 of the service adapter 118, by specifying the information about the data type of the corresponding parameter, and the addresses of storage regions corresponding to the byte sequence type data region of the parameter to be obtained and the parameter data type data region within the output data object. Then, the byte sequence type data is converted into parameter data type data, and stored in the parameter data type data region. To the user creation program 124, the value stored in the parameter data type data region of the output data object is returned.

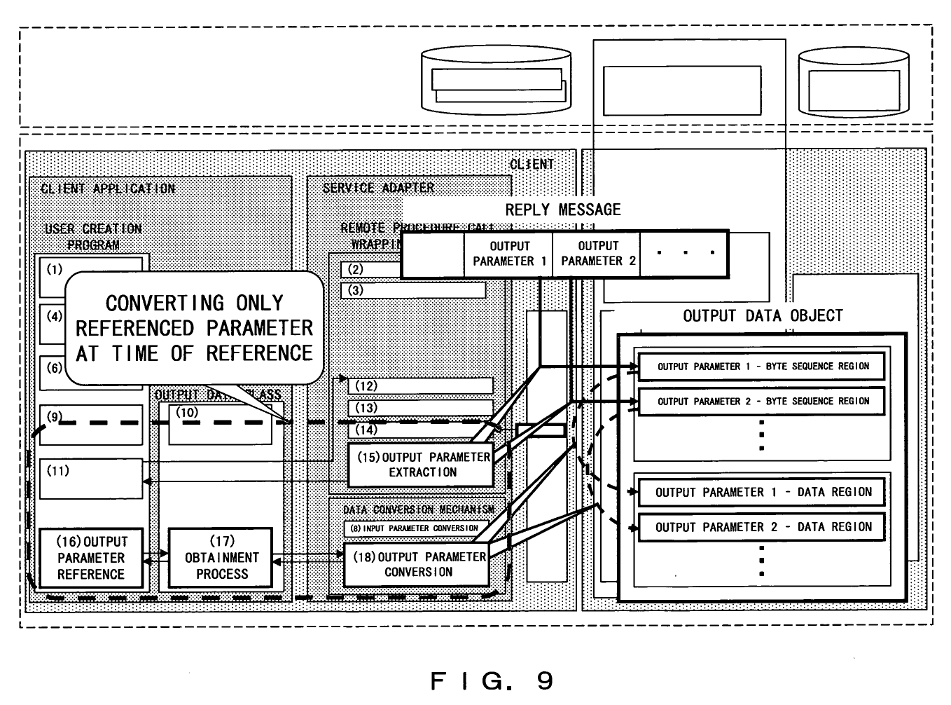

The preferred embodiment according to the present invention has been described with reference to FIGS. 5 to 8. According to the present invention, input/output parameters are encapsulated with input/output data classes when a client application calls a server application. Then, a data conversion process is executed by being restricted to a referenced output parameter when the client application references the output parameter. Conventionally, there is a problem that a data conversion is unconditionally performed for all output parameters by a client stub, and system performance at the time of execution significantly deteriorates due to the overhead of the data conversion process. According to the present invention, however, this problem can be overcome (see FIG. 9).

Next, an online stock trading system is described as a specific implementation example.

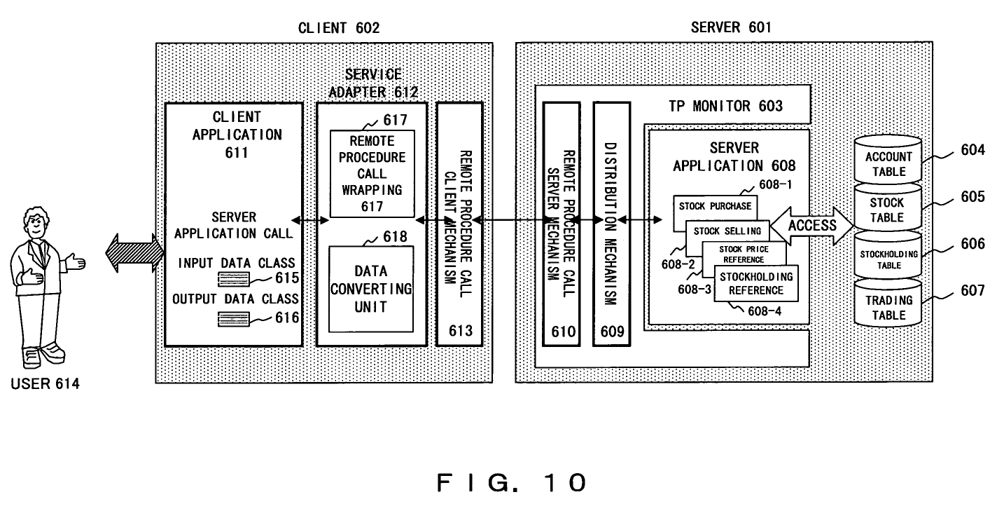

Its system configuration is shown in FIG. 10.

This online stock trading system is intended to provide services such as a stock purchase, stock selling, stock price reference, stockholding reference, etc. to a user who registers an account of this system, and makes an access from a client terminal to a server terminal.

This system is composed of a server 601 that is a side providing services, and a client 602 that is a user side receiving the services.

The server 601 is composed of a TP monitor 603, and a server application 608. The TP monitor 603 comprises a remote procedure call server mechanism 610, and a distribution mechanism 609. The server application 608 runs under the control of the TP monitor 603, and executes processes such as a stock purchase 608-1, stock selling 608-2, stock price reference 608-3, stockholding reference 608-4, etc. Although the server application 608 additionally provides various services such as an account opening process, an account update process, etc., they are omitted here. Furthermore, the server application 608 executes the processes by referencing databases such as an account table 604, a stock table 605, a stockholding table 606, a trading table 607, etc.

The client 602 is composed of a remote procedure call client mechanism 613 corresponding to the remote procedure call server mechanism 610 on the server side, a service adapter 612, and a client application 611. A user 614 receives the services via a client application 611 running on the client 602. An instruction request or input data, which the user 614 inputs to the client 602, is transferred as a communication message such as a request message, etc. from the client 602 to the server 601 via the service adapter 612, the remote procedure call mechanisms 613 and 610, and the TP monitor 603, and also process results are returned from the server 601 to the client 602 as a reply message in a similar manner.

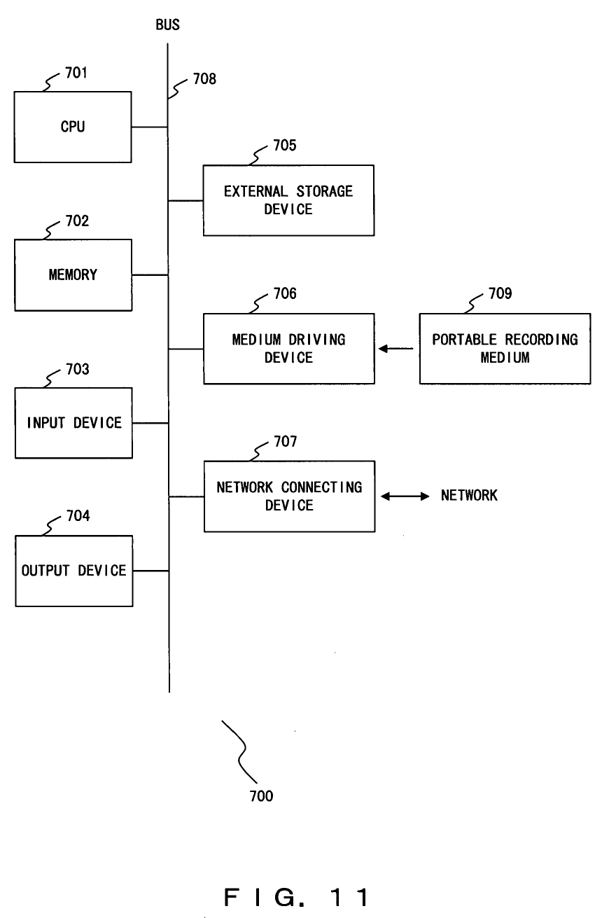

The client 602 and the server 601 are implemented by executing a program of the client application 611, the service adapter 612, the remote procedure call mechanisms 610 and 613, the distribution mechanism 609, the TP monitor 603, the server application 608, etc., for example, in an information processing device (computer) 700 shown in FIG. 11.

The information processing device 700 comprises a CPU 701, a memory 702, an input device 703, an output device 704, an external storage device 705, a medium driving device 706, and a network connecting device 707, which are interconnected by a bus 708.

The memory 702 includes, for example, a ROM (Read Only Memory), a RAM (Random Access Memory), etc., and stores the above described program and data for implementing the client 602 and the server 601.

The CPU 701 implements the server 601 and the client 602 by executing the program with the use of the memory 702.

The input device 703 is, for example, a keyboard, a pointing device, a touch panel, etc., and used to input an instruction or information from a user. The output device 704 is, for example, a display, a printer, etc., and used to output an inquiry, process results, etc. from the information processing device 700 to a user.

The external storage device 705 is, for example, a magnetic disk device, an optical disc device, a magneto-optical disc device, etc., the program and the data are stored in the external storage device 705, and can be loaded into the memory 702 and used depending on need.

The medium driving device 706 drives a portable recording medium 709, and accesses its recorded contents. As the portable recording medium 709, an arbitrary computer-readable recording medium such as a memory card, a memory stick, a floppy disk, a CD-ROM (Compact Disc-Read Only Memory), an optical disk, a magneto-optical disc, a DVD (Digital Versatile Disk), etc. is used. The program and the data are stored onto the portable recording medium 709, and can be loaded into the memory 702 and used depending on need.

The network connecting device 707 communicates with an external device via an arbitrary network (line) such as a LAN, a WAN, etc., and performs a data conversion accompanying a communication. Additionally, as occasion demands, the program and the data are received from an external device, and can be loaded into the memory 702 and used.

Details of the processes executed by the online stock trading system that is configured as shown in FIG. 10 with the information processing device 700 of FIG. 11 are described by taking as an example the process executed at the time of stock price reference.

With the “stock price reference” service, the stock price reference server application 608-3 retrieves the stock table 605 by using as a key a stock ID that the user 614 inputs to the client 602, and the client application 611 makes information about the stock name, the current stock price, the highest value, the lowest value, etc. of the corresponding stock visible on a display, etc.

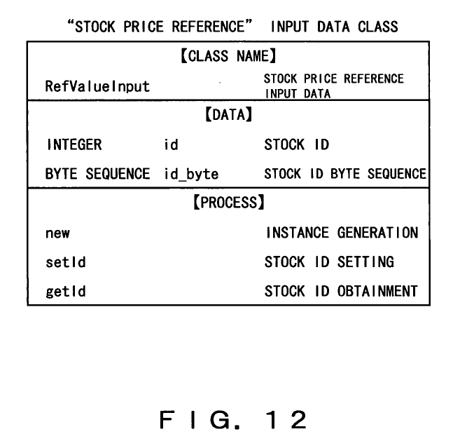

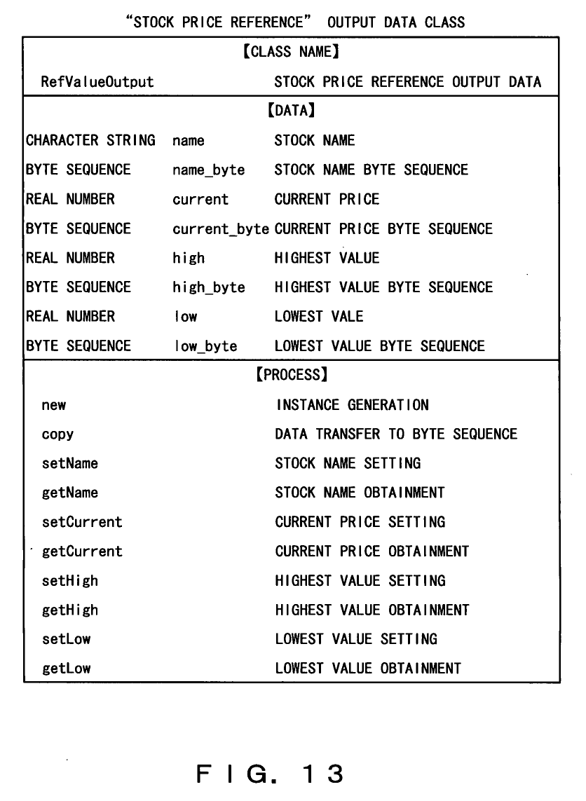

Initially, data structures of “stock price reference” input/output data classes, which are generated from “stock price reference” interface definition information with an interface definition conversion tool, etc. in a development environment not shown in FIG. 10, are depicted in FIGS. 12 and 13.

FIG. 12 shows a “stock price reference” input data class. Its class name is “RefValueInput (stock price reference input data)”, its data portion is composed of id, which is integer type data, and id_byte, which is byte sequence type data of id, and its process portion is composed of new method, setId method, and getId method. Their details are as follows.

In id, integer type data, which a user inputs to specify the name of a stock to be referenced, is stored.

In id_byte, data obtained by converting id, which is integer type data, into byte sequence type data when id is transmitted to the server is stored.

new method is a method for creating the instance of a corresponding class.

setId method is a method for executing a stock ID setting process.

getId method is a method for executing a stock ID obtainment process.

FIG. 13 shows a “stock price reference” output data class. Its class name is “RefValueOutput (stockprice reference output data)”. Its data portion is composed of name, which is character string type data, name_byte, which is byte sequence type data, current, which is real number type data, current_byte, which is byte sequence type data, high, which is real number type data, high_byte, which is byte sequence type data, low, which is real number type data, and low_byte, which is byte sequence type data. Its process portion is composed of new method, copy method, setName method, getName method, setCurrent method, getCurrent method, setHigh method, getHigh method, setLow method, and getLow method. Their details are as follows.

In name, a character string that indicates the name of a stock when being transferred to the application is stored.

In name_byte, byte sequence type data corresponding to the stock name in a reply message received from the server is stored.

In current, real number type data that indicates the current price of the stock when being transferred to the application is stored.

In current_byte, byte sequence type data that corresponds to the current price in the reply message received from the server is stored.

In high, real number type data that indicates the highest value of the stock price when being transferred to the application is stored.

In high_byte, byte sequence type data that corresponds to the highest value of the stock price in the reply message received from the server is stored.

In low, real number type data that indicates the lowest value of the stock price when being transferred to the application is stored.

In low_byte, byte sequence type data that corresponds to the lowest value of the stock price in the reply message received from the server is stored.

new method is a method for creating the instance of the corresponding class;

copy method is a method for transferring an output parameter portion within the reply message received from the server to a byte sequence type data region of the data portion of a corresponding output data object.

setName method is a method for executing a stock name setting process.

getName method is a method for executing a stock name obtainment process.

setCurrent method is a method for executing a current price setting process.

getCurrent method is a method for executing a current price obtainment process.

setHigh method is a method for executing a highest value setting process.

getHigh method is a method for executing a highest value obtainment process.

setLow method is a method for executing a lowest value setting process.

getLow method is a method for executing a lowest value obtainment process.

As shown in FIGS. 12 and 13, the present invention is characterized in that data management is made by pairing up with byte sequence type data of a corresponding parameter in correspondence with the actual input/output parameters id, name, current, high, low, etc.

The parameter data type data of the actual input/output parameters such as id, name, current, high, low, etc. are data with which the input/output data objects exchange data with a call source, and the byte sequence type data is data for structuring a message transmitted/received between the client application and the server application via a network.

In the output data object, which is the instance of the output data class, a portion corresponding to an output parameter included in the reply message received from the server is stored unchanged as byte sequence type data, and the decoding process (data type conversion, code conversion, etc.) for the corresponding parameter data is delayed until a request to reference the required parameter is made from the client application (see the later description).

The input/output data classes thus generated are embedded in the client application 611 as an input data class 615 and an output data class 616.

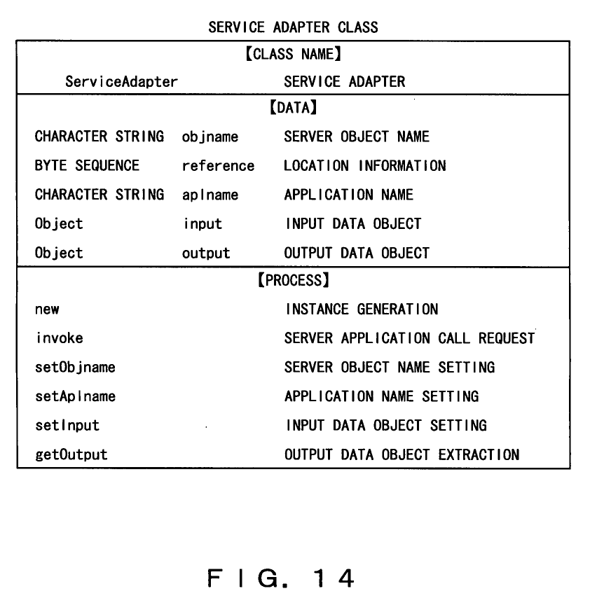

Next, the data structure of the service adapter class implementing the service adapter 612 of FIG. 10 is shown in FIG. 14.

The service adapter class has a class name “ServiceAdapter”. Its data portion is composed of objname, which is a character string type, reference, which is a byte sequence type, aplname, which is a character string type, input, which is an input data object type, and output, which is an output data object type. Its process portion is composed of new method, invoke method, setObjname method, setAplname method, setInput method, and setOutput method. Their details are as follows.

In objname, the name of a server object name is stored.

In reference, the location information of the server is stored.

In aplname, an application name is stored.

In input, an input data object is set.

In output, an output data object is set.

new method is a method for creating the instance of a corresponding class.

invoke method is a method for executing a call request process of a server application.

setObjname method is a method for executing a server object name setting process.

setAplname method is a method for executing an application name setting process.

setInput method is a method for executing an input data object setting process.

setOutput method is a method for executing an output data object extraction process.

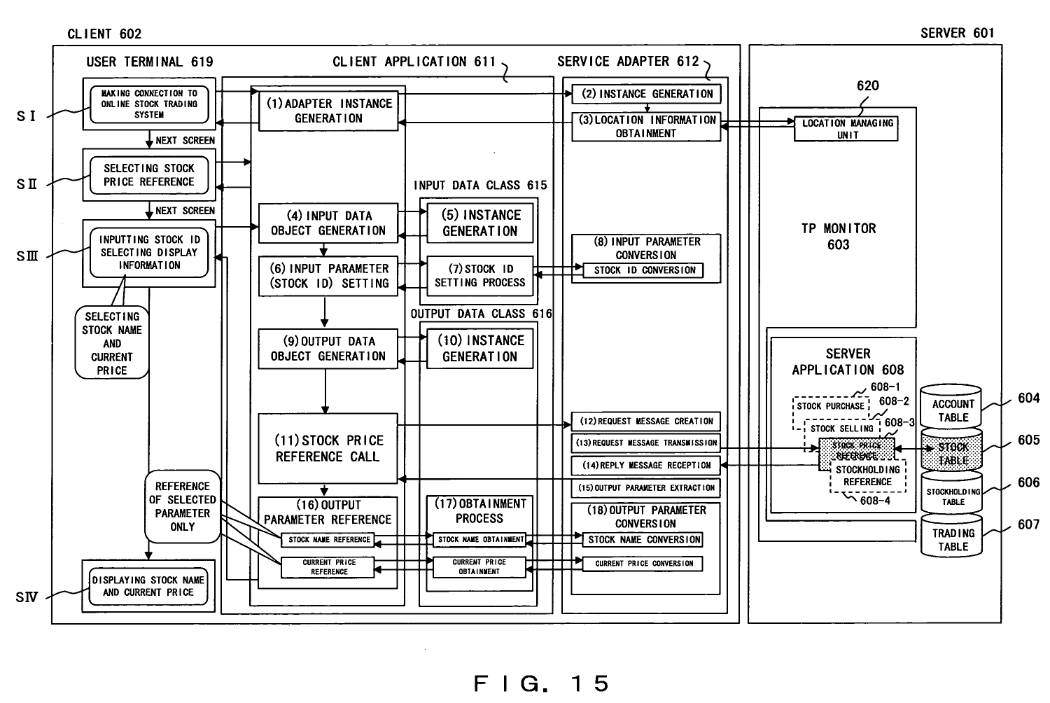

Next, the system flow from when the online stock trading system processes a request until when the system returns process results to a user in a case where the user makes the stock price reference request in the online stock trading system configured as shown in FIGS. 10 to 14 is depicted in FIG. 15. Namely, this is the system flow according to which the user makes a connection to the online stock trading system by using the client 602 in SI, the user selects a stock price reference in SII, the user inputs a stock ID on a stock price reference screen, and selects a stock name and a current price as display information in SIII, and the stock name and the current price are made visible on a display, etc. in SIV.

Initially, the user makes a connection to the online stock trading system in SI.

Then, the client application 611 makes (1) service adapter instance generation prior to a call of a server application. This is executed with new method of the service adapter class shown in FIG. 14.

Next, new method of the service adapter class, which is called in (1), makes (2) instance generation, the class shown in FIG. 14 is loaded into the memory 702 of FIG. 11, (3) obtainment of location information of the server object is made from the naming service (the location managing unit 620 of FIG. 15), and control is returned to the call source, namely, the client application 611.

Next, when the user selects the stock price reference in SII, the client application 611 displays a screen, which prompts the user to input a stock ID, etc., on a user terminal 619.

Then, in SIII, the user inputs the stock ID, and selects the name and the current price of the stock as display information.

Then, (4) generation of a “stock price reference” input data object is made, and the class shown in FIG. 12 is loaded into the memory 702 of FIG. 11 with new method of the “stock price reference” input data class in (5).

Then, (6) setID method, which is the input parameter setting process of FIG. 12, is called to set an input parameter, and (7) stock ID setting process is executed. With (7) setting process, the ID of the input stock is set in id of FIG. 12, and (8) conversion for the stock ID into a byte sequence type is made by the data converting unit 618 of the service adapter 612, and also the converted data is set in id_byte of FIG. 12.

Furthermore, (9) generation of a stock price reference output data object is made, and the class shown in FIG. 13 is loaded into the memory 702 of FIG. 11 with new method of the stock price reference output data class in (10).

Then, (11) call of the server application “stock price reference” 608-3 is made with invoke method of the service adapter class of FIG. 14 by specifying the “stock price reference” input/output data objects.

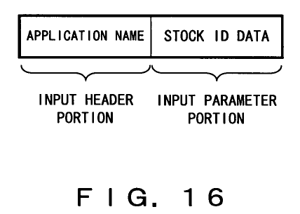

In (12), request message creation is made. The structure of a “stock price reference” request message is shown in FIG. 16. The “stock price reference” request message is composed of an input header portion including the name of a server application to be called, and an input parameter portion including a stock ID for specifying the name of a stock to be referenced.

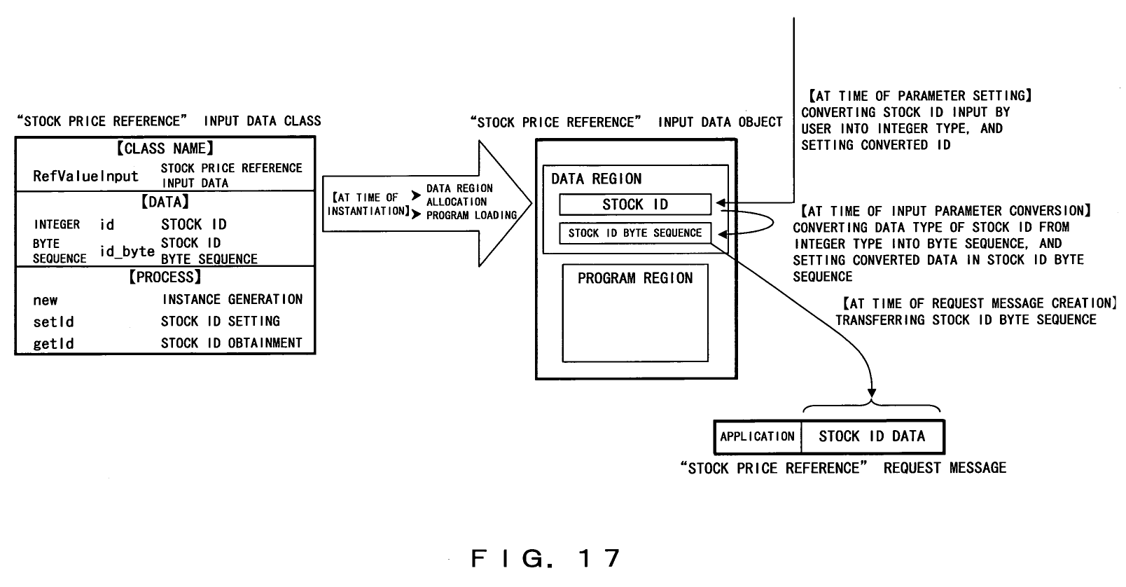

(12) request message creation is described with reference to the outline of the request message creation shown in FIG. 17.

Initially, the called server application “stock price reference” is stored in the input header portion of the request message. Additionally, as shown in FIG. 17, an integer type stock ID, and a byte sequence type stock ID are stored with (6) and (7) of FIG. 15 in the data region of the “stock price reference” input data object, which is instantiated from the “stock price reference” input data class, as shown in FIG. 17. The byte sequence type stock ID among these pieces of data is transferred to the input parameter portion of the request message, in which the stock ID is stored. In this way, the “stock price reference” request message is created.

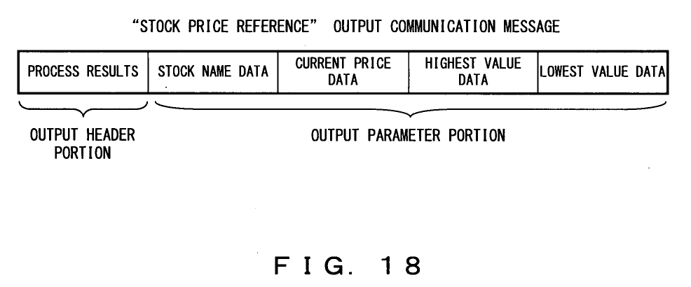

Then, (13) request message transmission is made to the server application “stock price reference” 608-3 next to (12) of FIG. 15. The “stock price reference” application 608-3 obtains the stock name, the current price, the highest value, and the lowest value, which are output parameters, based on the stock ID by referencing the stock table 605, creates a reply message, and transmits the reply message to the client 602. A structure of the “stock price reference” reply message is shown in FIG. 18. The “stock price reference” reply message is composed of an output header portion including process results, and an output parameter portion including output parameters such as a stock name, the current price, the highest value, and the lowest value.

The client 602 makes (14) reception of the reply message in the service adapter 612, and also makes (15) output parameter extraction from the reply message.

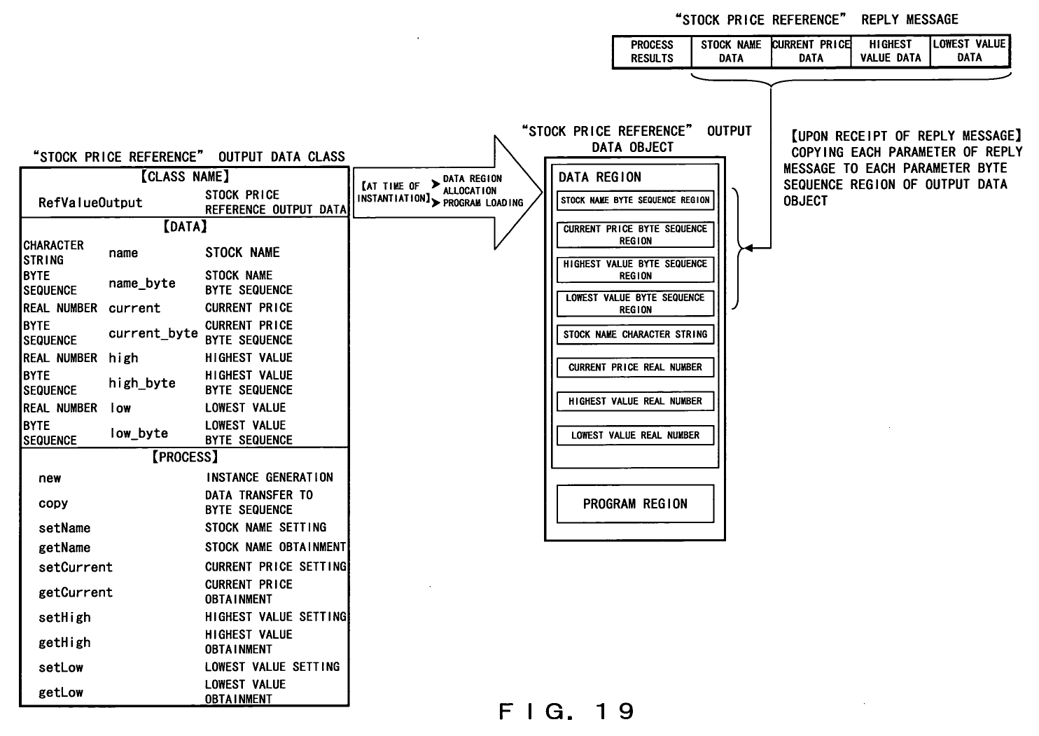

Here, “(15) output parameter extraction” is described with reference to FIG. 19.

As shown in FIG. 19, the “stock price reference” output data object, which is instantiated from the “stock price reference” output data class, has the data region shown in FIG. 13. Upon receipt of the reply message, stock name data, current price data, highest value data, and lowest value data are transferred and stored sequentially from the output parameter portion including the output parameters to the byte sequence type data region of the output data object. (15) “output parameter extraction” process, namely, copy method of FIG. 13 only transfers the byte sequence type output parameters within the reply message to the byte sequence type data region of the output data object unchanged, and does not execute any further processes.

After (15) of FIG. 15, control is returned to the client application 611.

Next, the client application 611 makes (16) reference of only a required output parameter in order to reference the stock name and the current price, which the user specifies as information to be displayed.

When (16) reference of the output parameter of the stock name is initially made, getName method of the output data object checks whether or not data is stored in name of a character string type in (17). If the data is not stored, a process for (18) output parameter conversion is executed by the data converting unit 618 of the service adapter 612, the converted data is stored in name of the character string type of the output data object, and the stock name of the character string type is returned to the call source. If converted data is already stored in name of the character string type when an output parameter is referenced, getName method returns the data of name unchanged to the call source without calling the data conversion process. Similarly, when (16) reference of the current price is made, getCurrent method checks whether or not data is stored in current of a real number type in (17). If the data is not stored, the process for (18) output parameter conversion is executed by the data converting unit 618 of the service adapter 612, and the converted data is stored in current of real number type of the output data object, and the current price data of real number type is returned to the call source.

Then, in SIV, the name and the current price of the stock are output by the client application 611 to the user terminal 619, and the series of processes is terminated.

As described above, according to this implementation example, in the process for (15) output parameter extraction after the reply message is received from the server application 608, the output parameters within the reply message are transferred to the byte sequence type data region within the output data object, but the data conversion is not performed. The data conversion is performed as (18) output parameter conversion of the service adapter 612 when the client application 611 calls (17) obtainment process of the output data object by making (16) output parameter reference. In the above description, the data conversion process is executed only for the output parameters such as the stock name and the current price, which the user selects as information to be displayed.

With a conventional system, a client stub performs a data conversion for all of output parameters such as a stock name, the current price, the highest value, and the lowest value after receiving a reply message from a server application, and notifies the parameters to the client application. Since the data conversion is performed only for an output parameter referenced by an application as described above according to the present invention, a useless data conversion process executed in the conventional system can be omitted, and performance at the time of system execution can be improved.

The flow of the entire system is described in detail as described above. A flow of steps other than the step of generating input/output data objects among the steps of (1) to (18) of FIG. 15 is described below to provide an additional explanation.

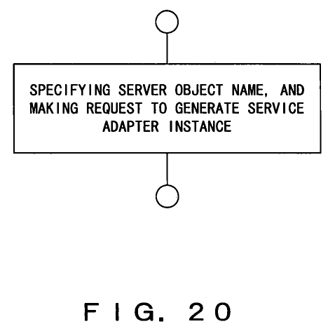

Initially, details of the flow of (1) adapter instance generation of FIG. 15 is shown in FIG. 20.

The client application 611 makes a request to generate a service adapter instance by specifying a service object name at the time of (1) adapter instance generation.

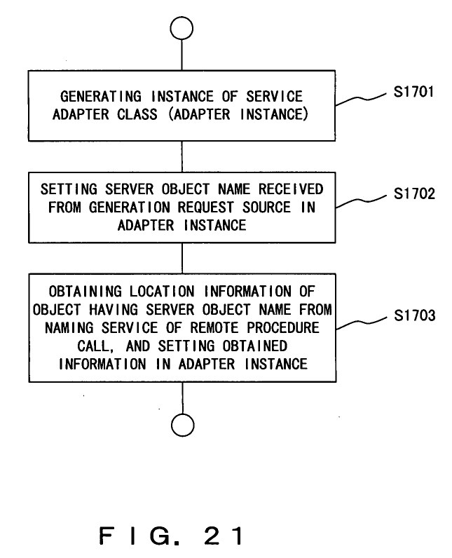

Next, the flow of (2) instance generation and (3) location information obtainment, which are shown in FIG. 15, is depicted in FIG. 21. In S1701, the service adapter 612 makes instance generation (corresponding to (2) of FIG. 15). In S1702, a server object name received from a service adapter generation request source is set in the adapter instance (the server object name is set in objname of FIG. 14). In S1703, the location information of the object having the server object name is obtained from the naming service (location managing unit 620) of the remote procedure call, and the location information is set in the adapter instance (the location information is set in reference of FIG. 14).

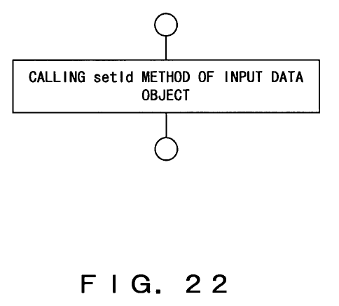

The flow of (6) input parameter settings of FIG. 15 is shown in FIG. 22.

The client application 611 calls setId method of the “stock price reference” input data object at the time of (6) input parameter settings.

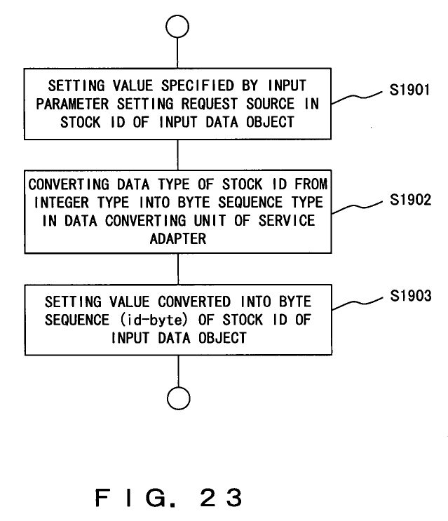

The flow of (7) stock ID setting process and (8) stock ID conversion, which are shown in FIG. 15, is depicted in FIG. 23. In S1901, a value specified by the input parameter setting request source is set in the stock ID of the “stock price reference” input data object (the value is set in id of FIG. 12). In S1902, the data converting unit 618 of the service adapter 612 converts the data type of the stock ID from the integer type into the byte sequence type. In S1903, the value converted into the stock ID byte sequence of the “stock price reference” input data object is set (the converted value is set in id_byte of FIG. 12).

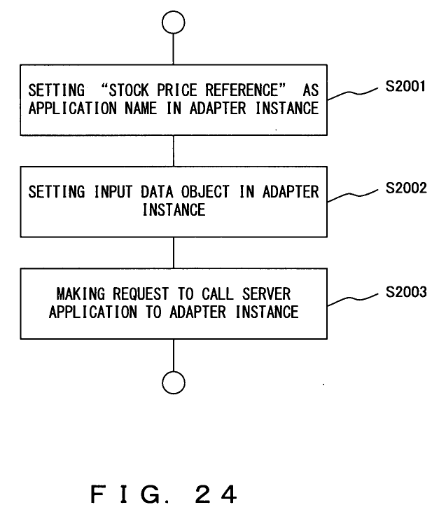

The flow of (11) server application “stock price reference” call of FIG. 15 is shown in FIG. 24. In S2001, “stock price reference” is set in the service adapter instance as an application name (“stock price reference” is set in aplname with setAplname method of FIG. 14). In S2002, the “stock price reference” input data object is set in the service adapter instance (RefValueInput is set in input with setInput method of FIG. 14). In S2003, a request to call the server application is made to the service adapter instance (the request to call the server application is made to invoke method of FIG. 14).

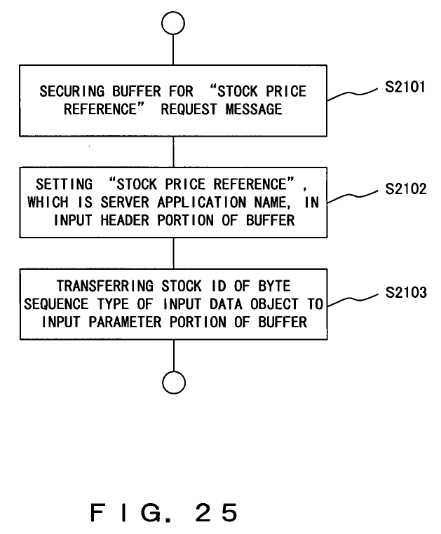

The flow of (12) request message creation of FIG. 15 is shown in FIG. 25. In S2101, a buffer for the “stock price reference” request message is secured in the memory 702 of FIG. 11. In S2102, “stock price reference”, which is the server application name, is set in the input header portion of the buffer. In S2103, the stock ID of the byte sequence type of the “stock price reference” input data object is transferred to the input parameter portion of the buffer. In this way, the “stock price reference” request message is created.

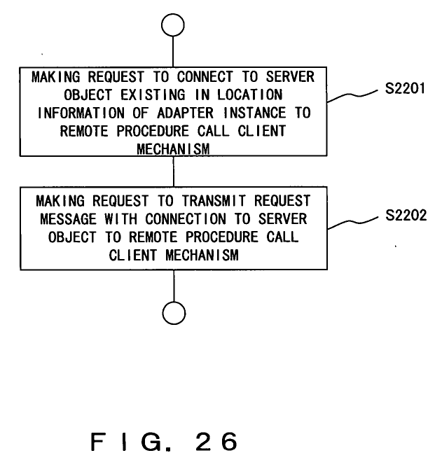

The flow of (13) request message transmission of FIG. 15 is shown in FIG. 26. In S2201, a request to connect to the server object existing in the location information of the service adapter instance is made to the remote procedure call client mechanism (613 of FIG. 10). In S2202, a request to transmit the request message is made to the remote procedure call client mechanism 613 with the connection to the server object. In this way, the request message is transmitted to the server application.

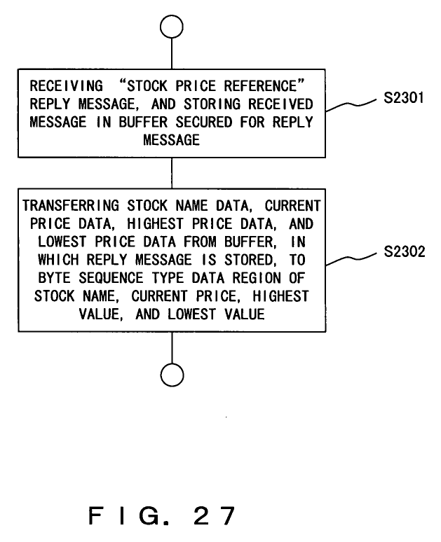

The flow of (14) reply message reception and (15) output parameter extraction, which are shown in FIG. 15, is depicted in FIG. 27. In S2301, the “stock price reference” reply message is received, and the received message is stored in the buffer secured for the reply message. In S2302, the stock name data, the current price data, the highest value data, and the lowest value data are transferred from the buffer, in which the reply message is stored, to the byte sequence type data region where the stock name, the current price, the highest value, and the lowest value data of the byte sequence type of the “stock price reference” output data object are stored (copy method of FIG. 11).

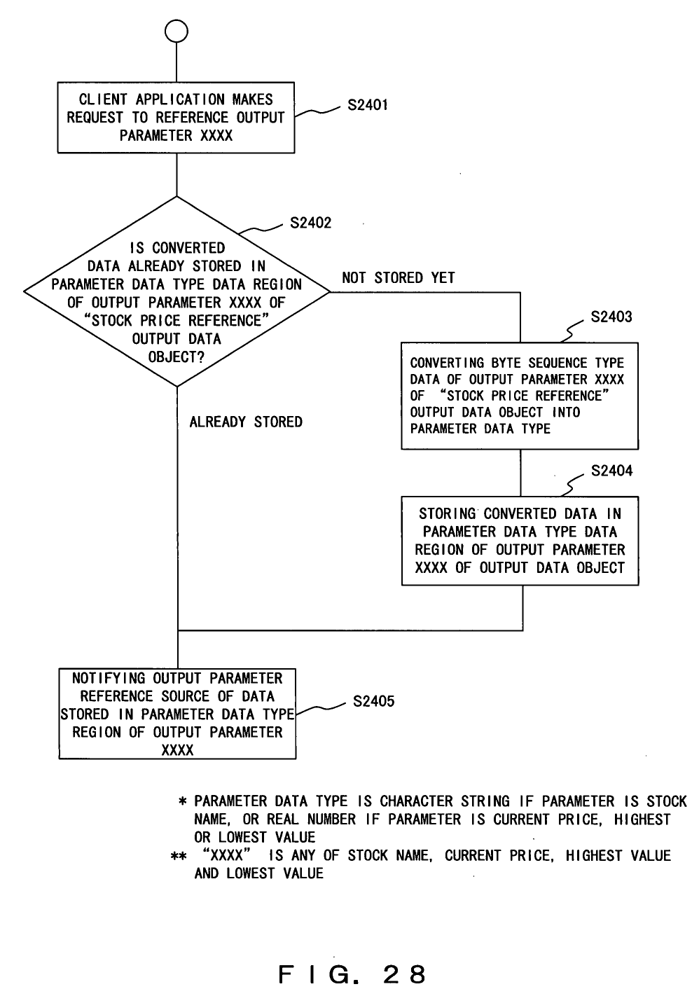

The flow of (16) output parameter reference, (17) obtainment process, and (18) output parameter conversion, which are shown in FIG. 15, is depicted in FIG. 28. In S2401, the client application 611 makes a request to reference an output parameter XXXX (XXXX may be any of the stock name, the current price, the highest value, and the lowest value) ((16) of FIG. 15). In S2402, a method for obtaining the output parameter XXXX checks whether or not converted data of the output parameter XXXX is stored in the parameter data type data region of the “stock price reference” output data object ((17) of FIG. 15). If the converted data is not stored yet, the flow proceeds to S2403, and the byte sequence type data of the output parameter XXXX of the “stock price reference” output data object is converted from the byte sequence type into the parameter data type ((18) of FIG. 15). The parameter data type is a character string if the output parameter is the stock name, or a real umber if the parameter is the current price, the highest value or the lowest value. Namely, the parameter data type is a data type that the output data object exchanges with a call source. Then, in S2404, the converted data is stored in the parameter data type data region of the output parameter XXXX ((17) of FIG. 15). Subsequently to S2402 and S2404, the data stored in the parameter data type data region of the output parameter XXXX is notified to the output parameter reference source in S2405 ((17) of FIG. 15).

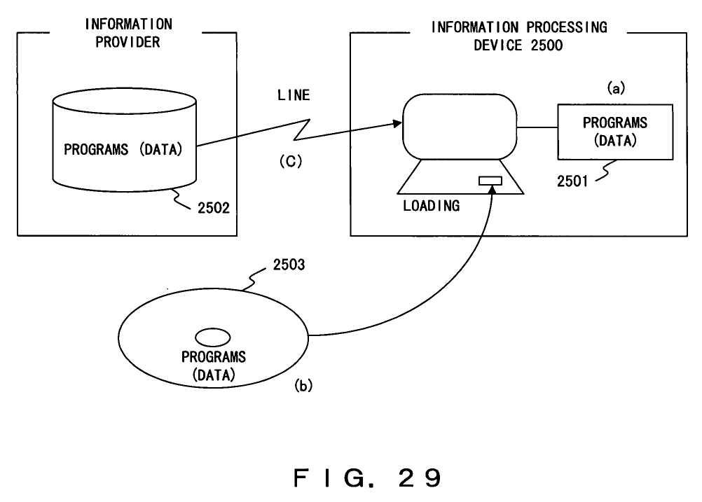

Up to this point, the implementation example of the present invention is described in detail. The server 601 and the client 602, which configure the system of this implementation example, are implemented by executing a program implementing the above described flows on an information processing device such as a computer, etc. FIG. 29 shows various methods for loading the program into the information processing device.

(a) shows a method with which the information processing device 2500 loads the program and data 2501, which are stored in an external storage device such as a hard disk, etc. of the information processing device 2500.

(b) shows a method with which the program and data 2503, which are recorded onto a portable recording medium such as a CD-ROM, a DVD, etc., are loaded via the medium driving device of the information processing device 2500.

(c) shows a method with which the program and data, which are provided by an information provider via a line such as a network, etc., are loaded via the communicating device of the information processing device 2500.

As described above, the present invention can be configured also as a program for causing an information processing device such as a computer, etc. to execute functions similar to those implemented by the configurations shown in the above described principal configuration and implementation example of the present invention. Additionally, the present invention can be configured also as a computer-readable recording medium on which is recorded a program for causing an information processing device such as a computer, etc. to execute functions similar to those implemented by the configurations shown in the above described principal configuration and implementation example of the present invention, when being used by the information processing device such as a computer, etc. Furthermore, the present invention can be configured also as a computer data signal which is embodied in a carrier wave and represents the above described program.

As stated above, the remote procedure call apparatus, which is the preferred embodiment of the present invention, is described in detail with reference to FIGS. 5 to 29. However, the present invention is not limited to the above description. Namely, the principle of the present invention is applicable also to any system where a client application calls a server application by using a remote procedure call, although the system operations, etc. performed when a stock price is referenced in the online stock trading system are described in detail above. The present invention is characterized in that the overhead of data conversion for output parameters at the time of a remote procedure call process in a conventional technique is improved. It goes without saying that various configurations and forms can be created within a scope which does not deviate from the gist of the present invention.

What is claimed is:

1. A remote procedure call apparatus having a remote procedure call mechanism for calling a server application with a remote procedure call, comprising:
client application means for calling the server application for the remote procedure call mechanism;
input data means for once storing an input parameter to be transmitted when said client application means calls the server application;
remote procedure call wrapping means for creating a request message to make a remote procedure call based on the input parameter stored in said input data means, for transmitting the request message to the server application, for waiting for a reply message, and for extracting one or more output parameters, which are included in the reply message and transmitted from the server application, upon receipt of the reply message;
output data means for storing the one or more output parameters extracted from said remote procedure call wrapping means, and for returning data corresponding to an output parameter to said client application means when said client application means references the output parameter; and
data conversion processing means for executing a data conversion process if the data conversion is not performed for the output parameter when said output data means returns the data of the output parameter referenced by said client application means.

2. The remote procedure call apparatus according to claim 1, wherein
a data type of the output parameter included in the reply message is a byte sequence type, and the data returned by said output data means when said client application means references the output parameter is a parameter data type.

3. The remote procedure call apparatus according to claim 2, wherein
said input data means and said output data means are embedded as class definitions in said client application means, and implemented by being generated as an input data object and an output data object when the remote procedure call is made.

4. The remote procedure call apparatus according to claim 3, wherein
the input data object and the output data object have a data region composed of a byte sequence type data region for storing data of the input parameter and the output parameter of the byte sequence type, which are included in a request message or a reply message, and a parameter data type data region for storing the input parameter and the output parameter.

5. A recording medium on which is recorded a program for causing an information processing device having a storing unit and a processing unit to execute a process with which a client application calls a server application with a remote procedure call, the process comprising:
generating an output data object by loading an output data class into the storing unit in synchronization with the remote procedure call;
transferring one or more output parameters included in a reply message to a data region of the output data object when the reply message is received from the server application; and
reading a corresponding output parameter from the data region when the client application references the output parameter, and returning data to the client application after executing a data conversion process if the data conversion process is not executed.

6. The recording medium according to claim 5, wherein
a data type of the output parameter included in the reply message is a byte sequence type, and the data returned when the client application references the output parameter is a parameter data type.

7. The recording medium according to claim 6, wherein
the output data object has a data region composed of a byte sequence type data region for storing the data of the output parameter of the byte sequence type, which is included in the reply message, and a parameter data type data region for storing the output parameter.

8. A method for implementing a process, with which a client application calls a server application with a remote procedure call, by using an information processing device having a storing unit and a processing unit, comprising:
generating an output data object by loading an output data class into the storing unit in synchronization with the remote procedure call;
transferring one or more output parameters included in a reply message to a data region of the output data object when the reply message is received from the server application; and
reading a corresponding output parameter from the data region when the client application references the output parameter, and returning data to the client application after executing a data conversion process if the data conversion process is not executed.

9. The method according to claim 8, wherein
a data type of the output parameter included in the reply message is a byte sequence type, and the data returned when the client application references the output parameter is a parameter data type.

10. The method according to claim 9, wherein
the output data object has a data region composed of a byte sequence type data region for storing the data of the output parameter of the byte sequence type, which is included in the reply message, and a parameter data type data region for storing the output parameter.

11. The method according to claim 10, wherein:
a server on which the server application is running is an information processing device having a storing unit and a processing unit; and
when the client application calls the server application with a remote procedure call,
a definition amount of location information required for the remote procedure call of the server application is routed in units of servers in response to a service request made with the remote procedure call,
a corresponding server application is made to execute a process, and
results of the process executed by the server application are generated as a reply message of one predetermined data type, which is not dependent on a data type of an output parameter, and the reply message is returned to a side of the client application.

12. A remote procedure call system having a client and a server, wherein:
the client comprises
one service adapter means for calling a server application with input/output data classes for a remote procedure call mechanism,
communicating means for making a communication using one data type, which is not dependent on a data type of an input/output parameter defined in the input/output data classes, between said service adapter means and a representative object included in the server,
decoding means for restricting decoding of a reply message, which is returned from the server in response to a service request, to a range of a parameter referenced by the client application; and
the server comprises
one representative object means including a server application distribution mechanism for routing a definition amount of location information required for a remote procedure call of the server application in response to a service request made by said service adapter means, and has the location information of each server application, and
communicating means for making a communication using one data type, which is not dependent on a data type of an input/output parameter defined in the input/output data classes, between said service adapter means and said representative object means.

13. The remote procedure call system according to claim 12, wherein:
a communication made respectively by said communicating means of the client and the server is made using byte sequence type data; and
the byte sequence type data is converted into a parameter data type in said decoding means of the client when the application references a parameter.
